(19) United States
(12) Patent Application Publication
(10) Pub. No.: US 2007/0008478 A1
(43) Pub. Date: Jan. 11, 2007

(54) Driving circuit, method, and display device having the same

(76) Inventors: In Lee, Yongin-si (KR); Jin-Oh Kwag, Suwon-si (KR); Cheong-Haeng Lee, Incheon-si (KR); Kwang-Sae Lee, Seoul (KR); Min-Su Lee, Seoul (KR); Young-Bin Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/483,914

(22) Filed: Jul. 10, 2006

(30) Foreign Application Priority Data
Jul. 11, 2005 (KR) 2005-62043

(51) Int. Cl. G02F 1/1345

(52) U.S. Cl. 349/152

(57) ABSTRACT

A driving circuit includes a semiconductor substrate, an electrode terminal, and a conductive bump. The electrode terminal is on the semiconductor substrate and includes a surface increasing portion on an upper surface of the electrode terminal to increase a surface area of the electrode terminal. The surface increasing portion has either various dimensions or constant dimensions. The conductive bump covers the surface increasing portion. Therefore, an image display quality of a display device is improved by reducing contact resistance between the electrode terminal and a signal line of a display panel.

This application claims priority to Korean Patent Application No. 2005-62043, filed on Jul. 11, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a driving circuit, a method, and a display device using the driving circuit. More particularly, the present invention relates to a driving circuit capable of improving an image display quality, a method of manufacturing the driving circuit and improving display quality, and a display device using the driving circuit.

2. Description of the Related Art

Electric apparatuses such as a portable communicating apparatus, a digital camera, a notebook computer, etc., include display devices. The display device includes a flat panel display device such as a liquid crystal display (“LCD”) device, an organic light emitting display (“OLED”) device, etc.

The LCD device includes a driving circuit mounted on an LCD panel. In addition, the portable communicating apparatus includes the LCD device of thin thickness and low power consumption.

The LCD panel is operated by the driving circuit. The driving circuit is formed on the LCD panel through a chip on glass (“COG”) method. In the COG method, the driving circuit is directly mounted on the LCD panel.

The driving circuit, in general, is electrically connected to a signal line of the LCD panel through an anisotropic conductive film (“ACF”) that includes a resin and a plurality of conductive particles within the resin. The driving circuit includes a plurality of bumps for input/output signals to the LCD panel.

In order to reduce the size of the LCD device, sizes and widths of the signal lines have been decreased, and a size of the driving circuit has also been decreased. When the sizes of the signal lines and the driving circuit are decreased, contact resistances between the bumps of the driving circuit, the ACF, and the signal lines are increased, which deteriorates the image display quality of the LCD device.

### BRIEF SUMMARY OF THE INVENTION

The present invention provides a driving circuit capable of improving an image display quality.

The present invention also provides a method of manufacturing the driving circuit.

The present invention also provides a display device using the driving circuit.

Exemplary embodiments of a driving circuit in accordance with the present invention include a semiconductor substrate, an electrode terminal and a conductive bump. The electrode terminal is on the semiconductor substrate and includes surface increasing portions on an upper surface of the electrode terminal increasing a surface area of the electrode terminal. The surface increasing portions have various dimensions. The conductive bump covers the surface increasing portions.

Other exemplary embodiments of a driving circuit in accordance with the present invention include a semiconductor substrate, an electrode terminal, and a conductive bump. The electrode terminal is on the semiconductor substrate and includes surface increasing portions on an upper surface of the electrode terminal increasing a surface area of the electrode terminal. The surface increasing portions each have substantially same dimensions. The conductive bump covers the surface increasing portions.

An exemplary method of manufacturing an exemplary embodiment of a driving circuit in accordance with the present invention is provided as follows.

A pretreatment solution is prepared. The pretreatment solution includes a reacting solution for forming silicon compound.

A treatment solution is prepared from the pretreatment solution and silicon. The treatment solution includes the silicon compound. A substrate having an electrode terminal that is partially exposed by the silicon compound is dipped in the treatment solution to partially etch the electrode terminal using the treatment solution.

Another exemplary method of manufacturing an exemplary embodiment of a driving circuit in accordance with the present invention is provided as follows. A photoresist pattern is formed on an electrode terminal that is exposed on a semiconductor substrate having a circuit part that converts an image signal into a driving signal. The electrode terminal is partially etched using the photoresist pattern as an etching mask to form a surface increasing portion on the electrode terminal.

Still another exemplary method of manufacturing an exemplary embodiment of a driving circuit in accordance with the present invention is provided as follows. An etching protector having a bead shape is attached to an electrode terminal that is exposed on a semiconductor substrate having a circuit part that converts an image signal into a driving signal. The electrode terminal is partially etched using the etching protector as an etching mask to form a surface increasing portion on the electrode terminal.

Still another exemplary method of manufacturing an exemplary embodiment of a driving circuit in accordance with the present invention is provided as follows. A catalyst accelerating an etching process is attached to an electrode terminal that is exposed on a semiconductor substrate having a circuit part that converts an image signal into a driving signal. The electrode terminal is partially etched using the catalyst as an etching mask to form a surface increasing portion on the electrode terminal.

Exemplary embodiments of a display device in accordance with the present invention include a display substrate and a driving circuit. The display substrate includes a display part displaying an image based on a driving signal applied from a signal input portion. The driving circuit includes a semiconductor substrate, an electrode terminal, and a driving circuit. The semiconductor substrate has a circuit part generating the driving signal. The electrode terminal is on the semiconductor substrate corresponding to the signal input portion. The electrode terminal includes surface increasing portions on an upper surface of the electrode terminal to increase a surface area of the electrode terminal. A conductive bump is on the electrode terminal and electrically connected to the signal input portion.

Exemplary embodiments of a method of improving an image display quality in a display device having a driving circuit and a display panel, includes decreasing contact resistance between an electrode terminal of the driving circuit and a signal line of the display panel by providing a non-planar conductive bump on the electrode terminal to increase a surface area of the conductive bump.

According to the present invention, the surface area of the electrode terminal of the driving circuit is increased so that a contact resistance of the electrode terminal is decreased, thereby improving an image display quality of the display device.

### BRIEF DESCRIPTION OF THE DRAWINGS

The above and other advantages of the present invention will become more apparent by describing in detail exemplary embodiments thereof with reference to the accompanying drawings, in which:

FIG. 1 is a perspective view showing an exemplary embodiment of a driving circuit in accordance with the present invention;

FIG. 2 is a cross-sectional view taken along line I-I′ shown in FIG. 1;

FIG. 3 is an enlarged cross-sectional view showing portion ‘A’ shown in FIG. 2;

FIGS. 4A to 4D are plan views showing exemplary surface increasing portions shown in FIG. 3;

FIG. 5 is a cross-sectional view showing another exemplary embodiment of a driving circuit in accordance with the present invention;

FIG. 6 is an enlarged cross-sectional view showing portion ‘B’ shown in FIG. 5;

FIG. 7 is a plan view showing an exemplary electrode terminal shown in FIG. 6;

FIG. 8 is a flow chart showing an exemplary method of manufacturing an exemplary embodiment of a driving circuit in accordance with the present invention;

FIG. 9 is a cross-sectional view showing an exemplary pretreatment solution shown in FIG. 8;

FIG. 10 is a cross-sectional view showing silicon prepared in the exemplary pretreatment solution shown in FIG. 9;

FIG. 11 is a cross-sectional view showing an exemplary treatment solution manufactured from the exemplary pretreatment solution and the exemplary silicon shown in FIG. 10;

FIG. 12 is a cross-sectional view showing an exemplary semiconductor substrate having the exemplary embodiment of the driving circuit dipped in the exemplary treatment solution shown in FIG. 11;

FIGS. 13 to 16 are cross-sectional views showing another exemplary method of manufacturing an exemplary embodiment of a driving circuit in accordance with the present invention;

FIGS. 17 to 23 are cross-sectional views showing still another exemplary method of manufacturing an exemplary embodiment of a driving circuit in accordance with the present invention;

FIGS. 24 to 28 are cross-sectional views showing still another exemplary method of manufacturing an exemplary embodiment of a driving circuit in accordance with the present invention;

FIG. 29 is an exploded perspective view showing a portion of an exemplary embodiment of a display device in accordance with the present invention;

FIG. 30 is an enlarged perspective view showing portion ‘D’ shown in FIG. 29;

FIG. 31 is a cross-sectional view taken along line II-II′ shown in FIG. 30;

FIG. 32 is a cross-sectional view taken along line III-III′ shown in FIG. 30;

FIG. 33 is a cross-sectional view taken along line IV-IV′ shown in FIG. 29;

FIG. 34 is a plan view showing an exemplary first display substrate shown in FIG. 29; and

FIG. 35 is a cross-sectional view taken along line V-V′ shown in FIG. 29.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer, or intervening elements or layers may be present. In contrast, when an element or layer is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

Driving Circuit

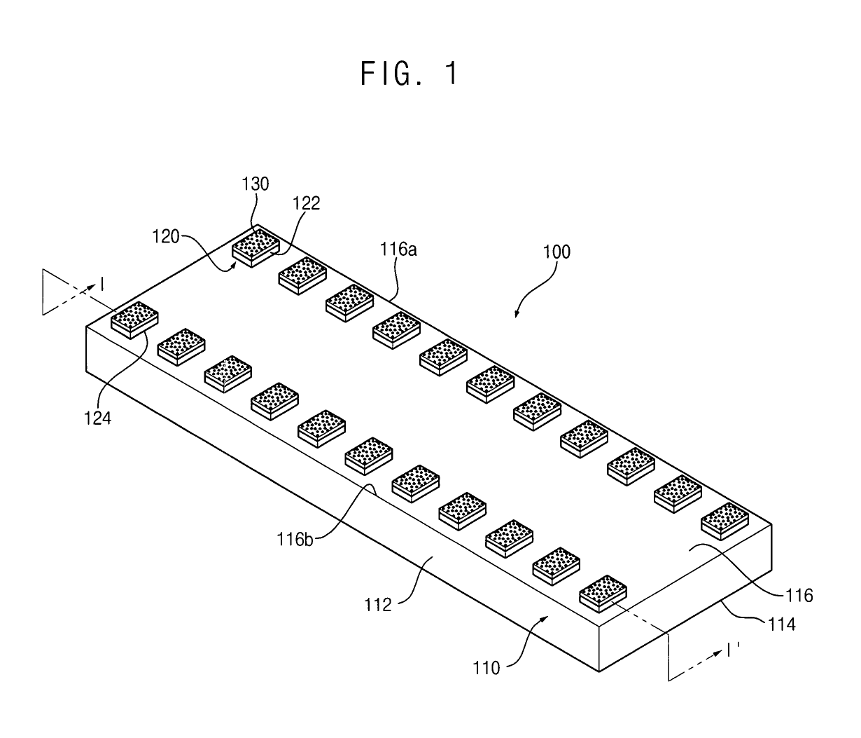

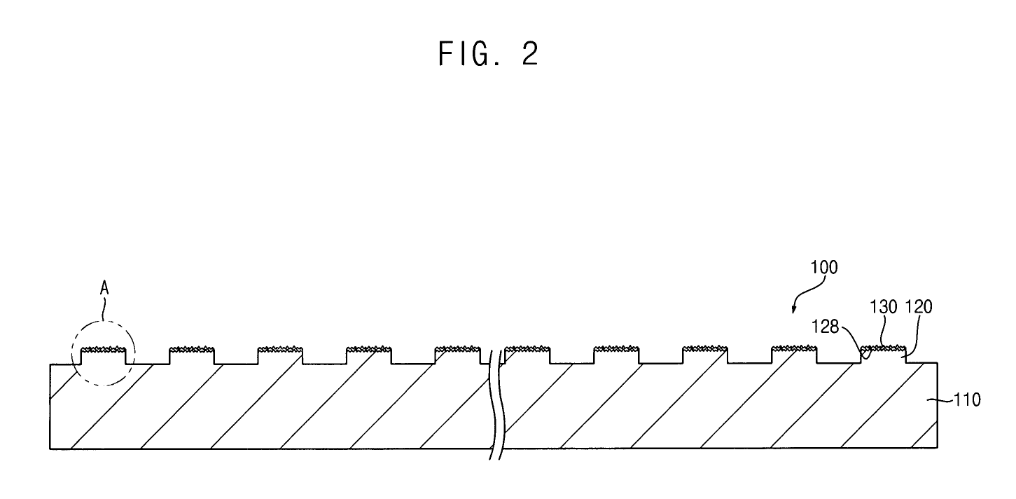

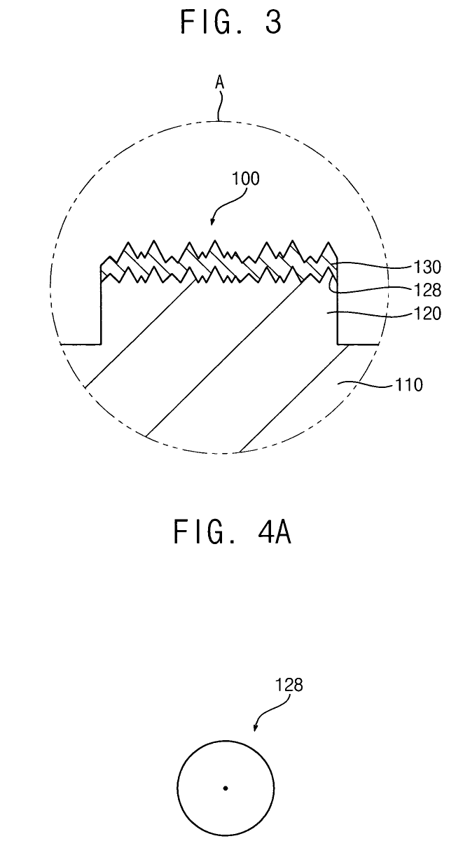

FIG. 1 is a perspective view showing an exemplary embodiment of a driving circuit in accordance with the present invention. FIG. 2 is a cross-sectional view taken along line I-I′ shown in FIG. 1. FIG. 3 is an enlarged cross-sectional view showing portion ‘A’ shown in FIG. 2.

Referring to FIGS. 1 to 3, a driving circuit 100 includes a semiconductor substrate 110, an electrode terminal 120, and a conductive bump 130. Alternatively, the driving circuit 100 may further include a plurality of electrode terminals 120 and a plurality of conductive bumps 130.

For example, the semiconductor substrate 110 may be a mono-crystalline silicon wafer having a crystal face. Alternatively, the semiconductor substrate 110 may be an amorphous silicon (“a-Si”) substrate or a polysilicon substrate. The semiconductor substrate 110 may have a substantially rectangular plate shape that includes four side surfaces 112, an upper surface 114 and a bottom surface 116 corresponding to the upper surface 114.

The semiconductor substrate 110 may include a circuit part (not shown) that converts an externally provided image signal into a driving signal. The circuit part (not shown) may be formed through thin film manufacturing processes.

The electrode terminal 120 may be formed on the bottom surface 116 of the semiconductor substrate 110. The electrode terminal 120 may protrude from a face of the bottom surface 116. The electrode terminal 120 includes a signal input terminal portion 122 and a signal output terminal portion 124. The externally provided image signal is applied to the circuit part (not shown) of the semiconductor substrate 110 through the signal input terminal portion 122. The driving signal generated from the circuit part (not shown) is applied to the driving circuit 100 through the signal output terminal portion 124.

A plurality of the signal input terminal portions 122 may be arranged on the bottom surface 116 adjacent a first edge line 116a of the semiconductor substrate 110. That is, the signal input terminal portions 122 may be dispersed along a side of the semiconductor substrate 110.

A plurality of the signal output terminal portions 124 may be arranged on the bottom surface 116 adjacent a second edge line 116b of the semiconductor substrate 110. The second edge line 116b is opposite to the first edge line 116a. That is, the signal output terminal portions 124 may be dispersed along another side of the semiconductor substrate 110.

Referring to FIG. 3, at least one surface increasing portion 128 may be formed on an upper surface of the electrode terminal 120 that includes the signal input terminal portion 122 and the signal output terminal portion 124. That is, the electrode terminal 120 includes a lower surface attached to the bottom surface 116 of the semiconductor substrate 110 and an upper surface spaced from the bottom surface 116. The upper surface of the electrode terminal 120 includes the at least one surface increasing portion 128. In absence of the at least one surface increasing portion 128, the upper surface of the electrode terminal 120 would have a smaller surface area than the electrode terminal 120 having the at least one surface increasing portion 128.

Each of the surface increasing portions 128, also termed surface area increasing portions 128, may have various dimensions. The dimension includes height, bottom surface, volume, etc. For example, the height of each surface increasing portion 128 may be about 1 to about 10 μm.

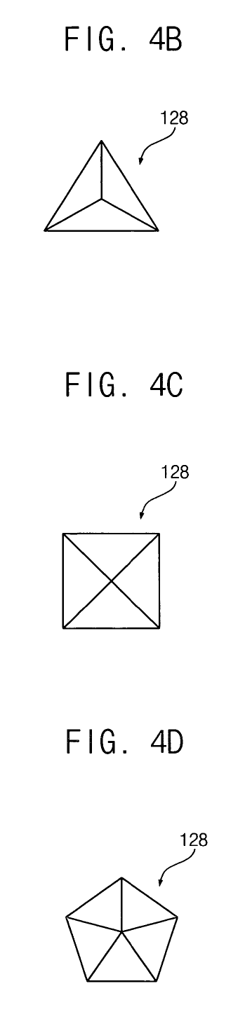

FIGS. 4A to 4D are plan views showing exemplary surface increasing portions shown in FIG. 3.

Referring to FIGS. 4A to 4D, the surface increasing portion 128 may have a substantially circular cone shape, a substantially triangular pyramid shape, a substantially quadrangular pyramid shape, a substantially polygonal pyramid shape, etc., when viewed from above, that is, when viewed in plan.

A plurality of the surface increasing portions 128 may be formed on each electrode terminal 120. For example, when a length of the electrode terminal 120 is about 150 μm and a width of the electrode terminal 120 is about 50 μm, a surface area of the electrode terminal 120, not including the surface increasing portions 128, is about 7,500 μm², and a surface area of each of the surface increasing portions 128 may be about 1 μm² to about 100 μm². The number of the surface increasing portions 128 having the surface of about 1 μm² to about 100 μm² on the electrode terminal 120 having the surface area of about 7,500 μm² may be about 75 to about 7,500. As another example, when the surface area of the electrode terminal 120 is about 1,000 μm², not including the surface increasing portions 128, and the surface area of each of the surface increasing portions 128 is about 1 μm² to about 100 μm², the number of the surface area increasing portions 128 may be about 10 to about 1,000. The surface area of the electrode terminal 120 is increased by the surface area increasing portions 128. That is, the electrode terminal 120 having the surface area increasing portions 128 has a greater surface area than an electrode terminal having a planar upper surface.

The conductive bump 130 is formed on the electrode terminal 120. The conductive bump 130 may include a highly conductive metal. Examples of the metal that can be used for the conductive bump 130 include gold Au, silver Ag, aluminum Al, copper Cu, etc. The conductive bump 130 may be formed on the electrode terminal 120 through a sputtering process, a chemical vapor deposition process, a plating process, an electro less plating process, etc. For example, the conductive bump 130 has a convex and concave shape to be combined with the electrode terminal 120. That is, a surface area of the conductive bump 130 is also increased as compared to a surface area of a conductive bump having planar faces.

In FIGS. 1 to 4D, the surface area of the conductive bump 130 is greatly increased to decrease a contact resistance between the electrode terminal 120 and a signal line of a display panel that is electrically connected to the conductive bump 130.

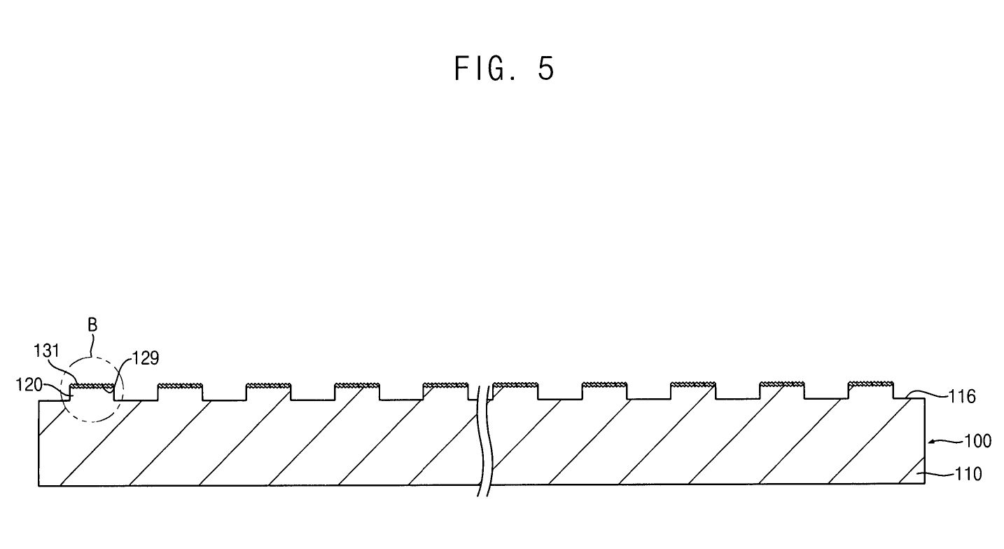

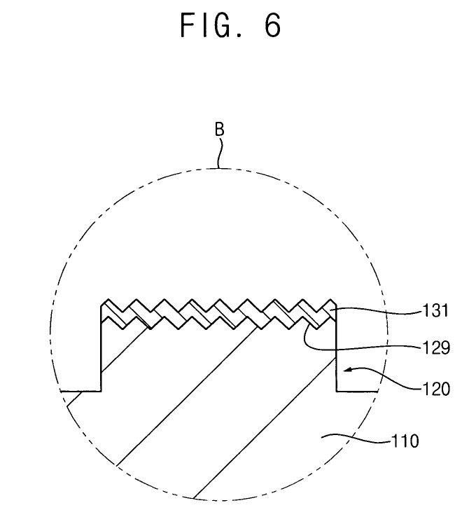

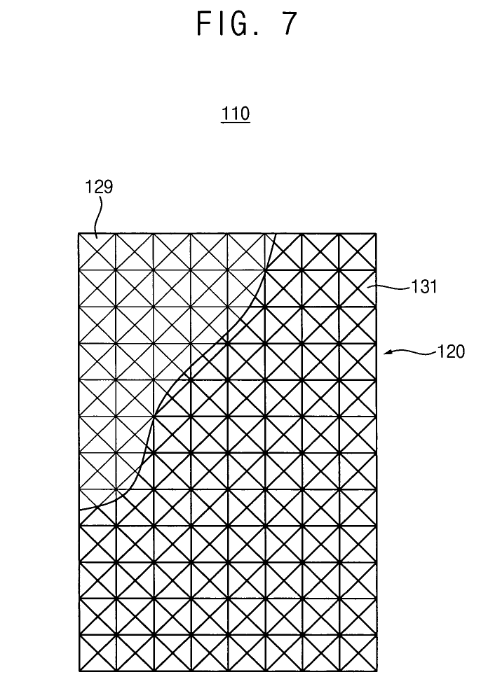

FIG. 5 is a cross-sectional view showing another exemplary embodiment of a driving circuit in accordance with the present invention. FIG. 6 is an enlarged cross-sectional view showing portion ‘B’ shown in FIG. 5. FIG. 7 is a plan view showing an exemplary electrode terminal shown in FIG. 6.

Referring to FIGS. 5 to 7, a driving circuit 100 includes a semiconductor substrate 110, an electrode terminal 120, and a conductive bump 131.

The semiconductor substrate 110 may include a circuit part (not shown) that converts an externally provided image signal into a driving signal. The circuit part (not shown) may be formed through thin film manufacturing processes.

The electrode terminal 120 may be formed on a bottom surface 116 of the semiconductor substrate 110. The electrode terminal 120 may protrude from a face of the bottom surface 116. The electrode terminal 120 receives the externally provided image signal or outputs the driving signal generated from the circuit part (not shown). The electrode terminal 120 may include signal input terminal portions and signal output terminal portions as in the prior embodiment.

At least one surface increasing portion 129, also termed surface area increasing portion 129, may be formed on an upper surface of the electrode terminal 120. The surface increasing portion 129 may be protruded from the upper surface of the electrode terminal 120. That is, the electrode terminal 120 includes a lower surface attached to the bottom surface 116 of the semiconductor substrate 110 and an upper surface spaced from the bottom surface 116. The upper surface of the electrode terminal 120 includes the at least one surface increasing portion 129. In absence of the at least one surface increasing portion 129, the upper surface of the electrode terminal 120 would have a smaller surface area than the electrode terminal 120 having the at least one surface increasing portion 129.

In FIGS. 5 to 7, a plurality of the surface increasing portions 129 is formed on the upper surface of the electrode terminal 120. The surface increasing portions 129 may have substantially the same dimensions. The dimensions include height, bottom surface, volume, etc. For example, the height of the surface increasing portion 129 may be between about 1 to about 10 μm, with each surface increasing portion 129 having substantially the same height. The surface increasing portion 129 may have a substantially circular cone shape, a substantially triangular pyramid shape, a substantially quadrangular pyramid shape, a substantially polygonal pyramid shape, etc., when viewed from above in plan view.

For example, when a length of the electrode terminal 120 is about 150 μm and a width of the electrode terminal 120 is about 50 μm, a surface area of the electrode terminal 120, not including the surface increasing portions 129, is about 7,500 μm², and a surface area of each of the surface increasing portions 129 is about 1 μm² to about 100 μm². The number of the surface increasing portions 129 having the surface of about 1 μm² to about 100 μm² on the electrode terminal 120 having the surface area of about 7,500 μm² may be about 75 to about 7,500. As another example, when the surface area of the electrode terminal 120 is about 1,000 μm², not including the surface increasing portions 129, and the surface area of each of the surface increasing portions 129 is about 1 μm² to about 100 μm², the number of the surface area increasing portions 129 may be about 10 to about 1,000. The surface area of the electrode terminal 120 is increased by the surface area increasing portions 129. That is, the electrode terminal 120 having the surface increasing portions 129 has a greater surface area than an electrode terminal having a planar upper surface.

The conductive bump 131 is formed on the electrode terminal 120. The conductive bump 131 may include a highly conductive metal. Examples of the metal that can be used for the conductive bump 131 include gold Au, silver Ag, aluminum Al, copper Cu, etc. The conductive bump 131 may be formed on the electrode terminal 120 through a sputtering process, a chemical vapor deposition process, a plating process, an electro less plating process, etc. For example, the conductive bump 131 has a convex and concave shape to be combined with the electrode terminal 120. That is, a surface area of the conductive bump 131 is also increased as compared to a surface area of a conductive bump having a planar surface.

In FIGS. 5 to 7, the surface area of the conductive bump 131 is greatly increased to decrease a contact resistance between the electrode terminal 120 and a signal line of a display panel that is electrically connected to the conductive bump 131.

Method of Manufacturing a Driving Circuit

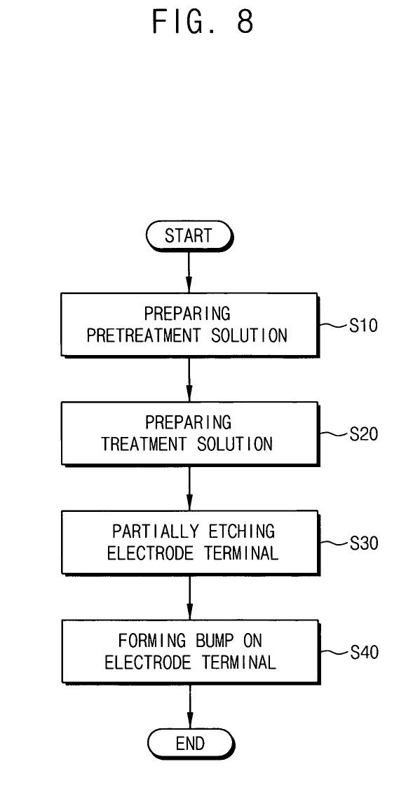

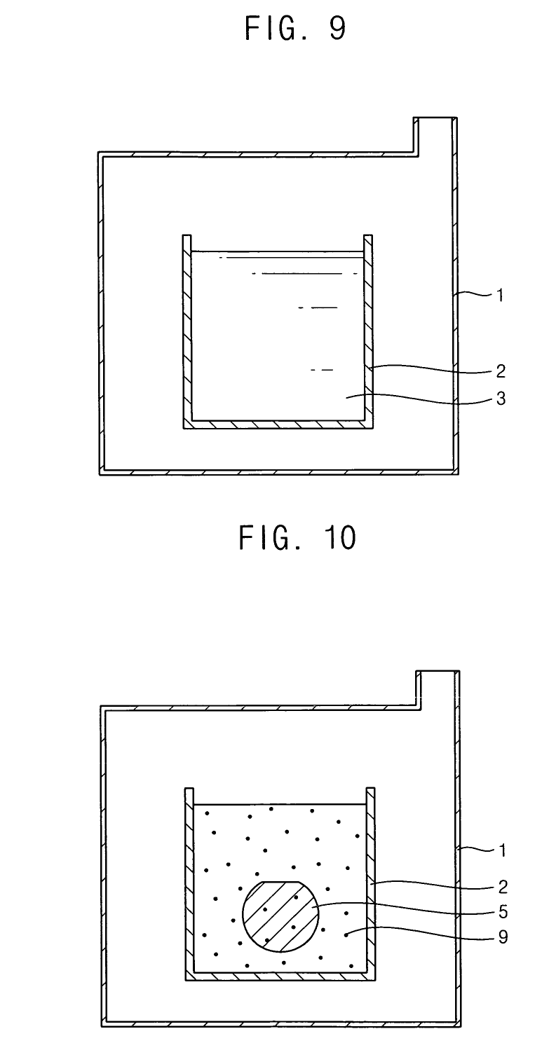

FIG. 8 is a flow chart showing an exemplary method of manufacturing an exemplary embodiment of a driving circuit in accordance with the present invention. FIG. 9 is a cross-sectional view showing an exemplary pretreatment solution shown in FIG. 8.

Referring to FIGS. 8 and 9, in order to manufacture the driving circuit, a circuit part (not shown) that converts an image signal into a driving signal is formed on a semiconductor substrate such as a silicon wafer.

A photoresist thin film is formed on the semiconductor substrate through a spin coating method. The photoresist thin film is exposed and developed so that electrode terminals of the semiconductor substrate are exposed. The electrode terminals are electrically connected to external signal lines, respectively, during manufacture of a display device.

As shown in step S10, in order to partially etch the semiconductor substrate in a closed chamber 1, a pretreatment solution 3 that includes a reacting solution is prepared in a vessel 2. The reacting solution is chemically reacted with the semiconductor substrate.

In particular, the reacting solution is chemically reacted with silicon of the semiconductor substrate to partially etch the silicon to generate solid particles. Examples of the solid particles that are generated by the chemical reaction include silicon oxide particles, metal silicon oxide particles, etc.

The reacting solution may include sodium hydroxide, potassium hydroxide, de-ionized water, etc. The de-ionized water may be pure water having substantially no ions. Alternatively, the reacting solution may include sodium hydroxide, potassium hydroxide, de-ionized water, isopropyl alcohol, etc.

In FIGS. 8 and 9, the reacting solution includes the sodium hydroxide, the potassium hydroxide, the de-ionized water and the isopropyl alcohol.

For example, a volumetric ratio of the de-ionized water, the sodium hydroxide and the isopropyl alcohol is about 1 L:15×10⁻³ L:14×10⁻³ L. That is, the volumetric ratio of the de-ionized water, the sodium hydroxide and the isopropyl alcohol is about 14 L:210 mL:200 mL.

A temperature of the pretreatment solution 3 that includes the de-ionized water, the sodium hydroxide and the isopropyl alcohol is about 85° C. to about 95° C. For example, the temperature of the pretreatment solution 3 may be about 90° C. In addition, the pretreatment solution 3 that is received in the vessel 2 is stirred by nitrogen bubbles that are ejaculated through a nitrogen ejaculation conduit (not shown) that is in the pretreatment solution 3 for about one minute to about two minutes.

FIG. 10 is a cross-sectional view showing silicon prepared in the pretreatment solution shown in FIG. 9.

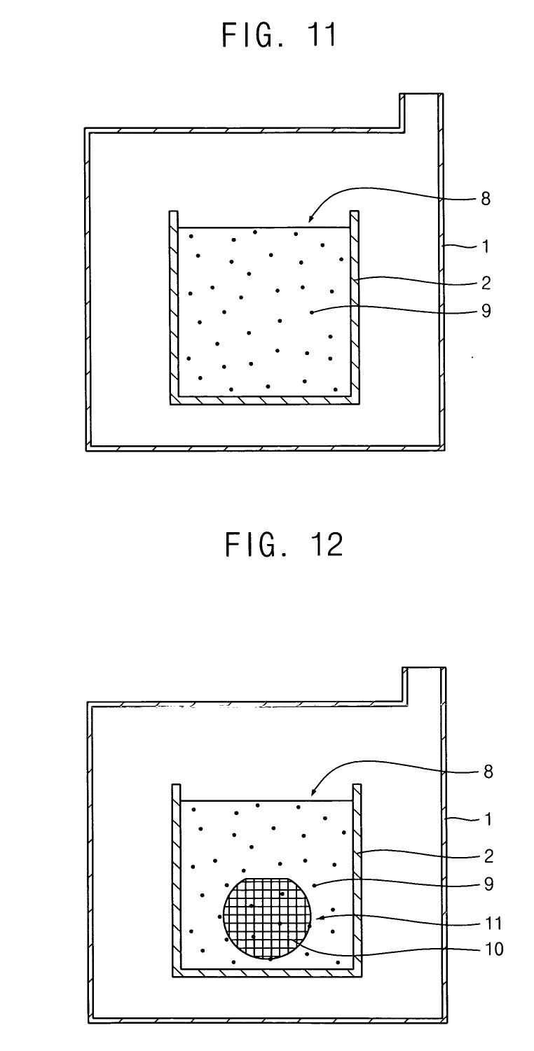

Referring to FIG. 10 and step S20, a bare wafer 5 is prepared in the pretreatment solution 3 (as shown in FIG. 9) to prepare a treatment solution 8 (as no shown in FIG. 11). The bare wafer 5 includes silicon. Diameter and thickness of the bare wafer 5 are about 8 inches (203 mm) and about 480 μm, respectively. For example, twenty four bare wafers 5 may be prepared in the pretreatment solution 3.

FIG. 11 is a cross-sectional view showing an exemplary treatment solution manufactured from the exemplary pretreatment solution and the exemplary silicon shown in FIG. 10.

Referring to FIGS. 8 and 11, the bare wafer 5 is chemically reacted with the sodium hydroxide of the pretreatment solution 3 so the bare wafer 5 is partially etched to form sodium silicate 9. The treatment solution 8 is a mixture of the sodium silicate 9 and the pretreatment solution 3.

In FIGS. 8 and 11, the bare wafer 5 is dipped in the pretreatment solution 3 for about three to five times.

FIG. 12 is a cross-sectional view showing an exemplary semiconductor substrate having the exemplary driving circuit dipped in the exemplary treatment solution shown in FIG. 11.

Referring to FIGS. 8 and 12, and as shown in step S30, a semiconductor substrate 11 having a driving circuit 10 is dipped in the treatment solution 8. The driving circuit 10 includes a circuit part (not shown). The semiconductor substrate 11 includes a photoresist pattern (not shown) that exposes the electrode terminal that is electrically connected to the external signal line (not shown) to protect a remaining portion of the driving circuit 10.

When the semiconductor substrate 11 having the photoresist pattern is dipped in the treatment solution 8, the sodium silicate 9 in the treatment solution 8 is attached to the semiconductor substrate 11. In addition, the sodium hydroxide of the treatment solution 8 is reacted with the electrode terminal to form a surface increasing portion on the electrode terminal. That is, a portion of the electrode terminal having the sodium silicate 9 is more etched than a remaining portion of the electrode terminal not having the sodium silicate 9 to form the surface increasing portion on the electrode terminal.

For example, the surface increasing portion may have a substantially circular cone shape, a substantially triangular pyramid shape, a substantially quadrangular pyramid shape, a substantially polygonal pyramid shape, etc. Alternatively, a plurality of the surface increasing portions may be formed on the electrode terminal. Each of the surface increasing portions may have various dimensions. That is, the dimensions of the surface increasing portions may be different from each other. The dimension includes height, bottom surface, volume, etc. For example, the height of the surface increasing portion may be about 1 to about 10 μm.

Referring again to FIG. 8 and step S40, a metal is deposited on the driving circuit having the surface increasing portion. Examples of the metal that can be deposited on the driving circuit include gold Au, silver Ag, aluminum Al, copper Cu, etc. The photoresist pattern remains on the circuit part except the electrode terminal so that the metal is deposited on the photoresist pattern and the electrode terminal. Therefore, a conductive bump having a corresponding cross-section to the surface increasing portion is formed on the electrode terminal.

The remaining photoresist pattern is stripped from the semiconductor substrate through an ashing process using oxygen plasma. The driving circuit is separated from a remaining portion of the semiconductor substrate using a laser beam, a sawing machine, etc. That is, the driving circuit is completed through a singulation process.

While particular embodiments of a manufacturing method have been described, it should be understood that alternative embodiments of certain steps and processes of the method would also be within the scope of these embodiments.

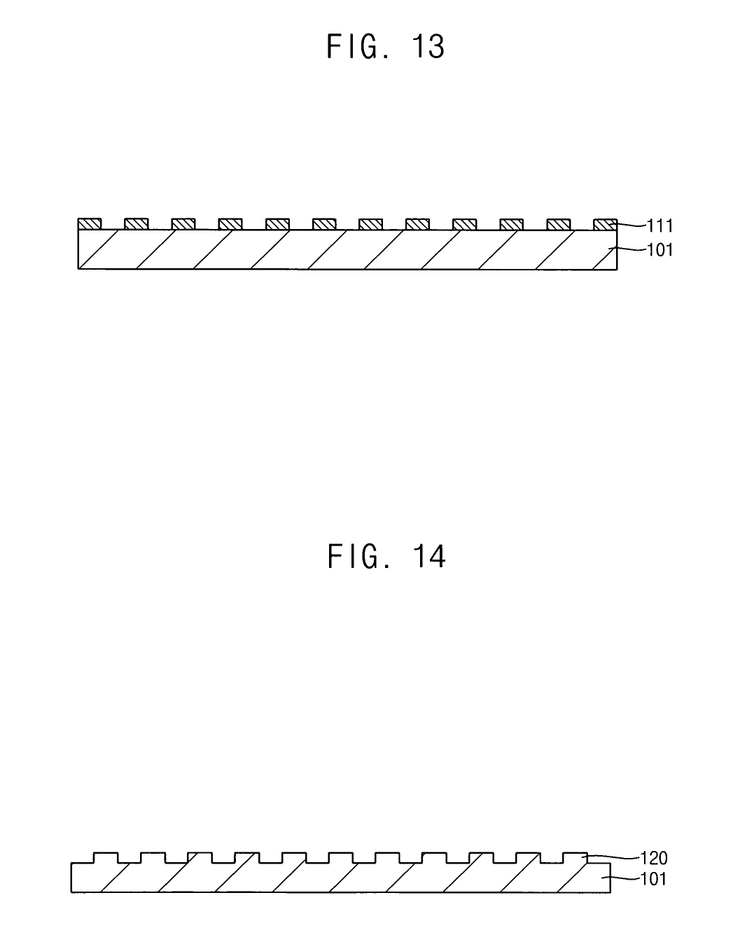

FIGS. 13 to 16 are cross-sectional views showing another exemplary method of manufacturing an exemplary embodiment of a driving circuit in accordance with the present invention.

FIG. 13 is a cross-sectional view showing an exemplary first photoresist pattern for forming exemplary electrode terminals on an exemplary semiconductor substrate.

Referring to FIG. 13, a photoresist thin film is coated on the semiconductor substrate 101 having the circuit part (not shown) through a spin coating process. The photoresist thin film is patterned through a photo process to form the first photoresist pattern 111 on the semiconductor substrate 101.

FIG. 14 is a cross-sectional view showing an exemplary electrode terminal formed on the exemplary semiconductor substrate shown in FIG. 13.

Referring to FIG. 14, the semiconductor substrate 101 is patterned through a dry etching process or a wet etching process using a first photoresist pattern 111 to form the electrode terminal 120 that is electrically connected to the circuit part on the semiconductor substrate 101.

The first photoresist pattern 111 is stripped from the semiconductor substrate 101 through an ashing process using oxygen plasma.

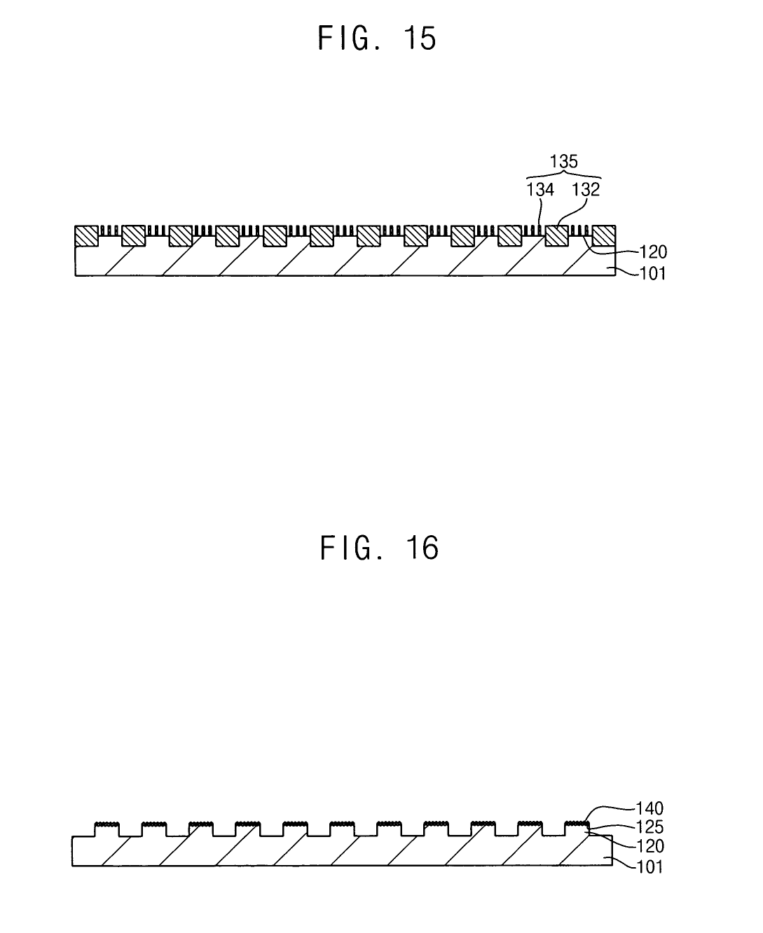

FIG. 15 is a cross-sectional view showing an exemplary second photoresist pattern that partially exposes the exemplary electrode terminal shown in FIG. 14.

Referring to FIG. 15, after the first photoresist pattern 111 is stripped from the semiconductor substrate 101, a photoresist thin film that covers the electrode terminal 120 is formed on the semiconductor substrate 101. The photoresist thin film is patterned through a photo process to form a second photoresist pattern 135 on the semiconductor substrate 101.

The second photoresist pattern 135 includes a first pattern portion 132 and a second pattern portion 134. The first pattern portion 132 covers the semiconductor substrate 101, but does not cover the electrode terminal 120. The second pattern portion 134 is on the electrode terminal 120. For example, a plurality of pattern portions 134 may be formed on the electrode terminal 120 in a matrix shape.

FIG. 16 is a cross-sectional view showing an exemplary surface increasing portion using the exemplary second photoresist pattern shown in FIG. 15 as an etching mask.

Referring to FIG. 16, the electrode terminal 120 that is partially exposed through the second photoresist pattern 135 is etched to form the surface increasing portion 125 having a constant dimension on the electrode terminal 120. That is, the surface increasing portions 125 may have substantially the same dimensions where the dimensions may include height, bottom surface, volume, etc.

A conductive bump 140 is selectively formed on the surface increasing portion 125 on the electrode terminal 120 of the semiconductor substrate 101.

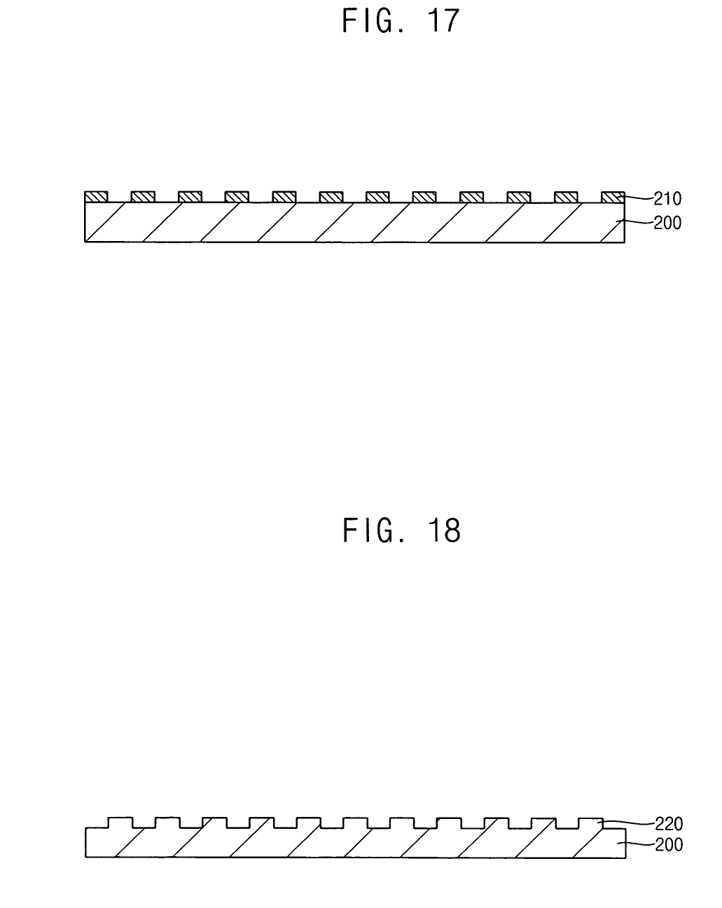

FIGS. 17 to 23 are cross-sectional views showing still another method of manufacturing an exemplary embodiment of a driving circuit in accordance with the present invention.

FIG. 17 is a cross-sectional view showing an exemplary first photoresist pattern for forming an exemplary electrode terminal on an exemplary semiconductor substrate.

Referring to FIG. 17, a photoresist thin film is coated on the semiconductor substrate 200 having the circuit part (not shown) through a spin coating process. The photoresist thin film is patterned through a photo process to form the first photoresist pattern 210 on the semiconductor substrate 200.

FIG. 18 is a cross-sectional view showing an exemplary electrode terminal formed on the exemplary semiconductor substrate shown in FIG. 17.

Referring to FIG. 18, the semiconductor substrate 200 is patterned through a dry etching process or a wet etching process using a first photoresist pattern 210 to form the electrode terminal 220 that is electrically connected to the circuit part on the semiconductor substrate 200.

The first photoresist pattern 210 is stripped from the semiconductor substrate 200 through an ashing process using oxygen plasma.

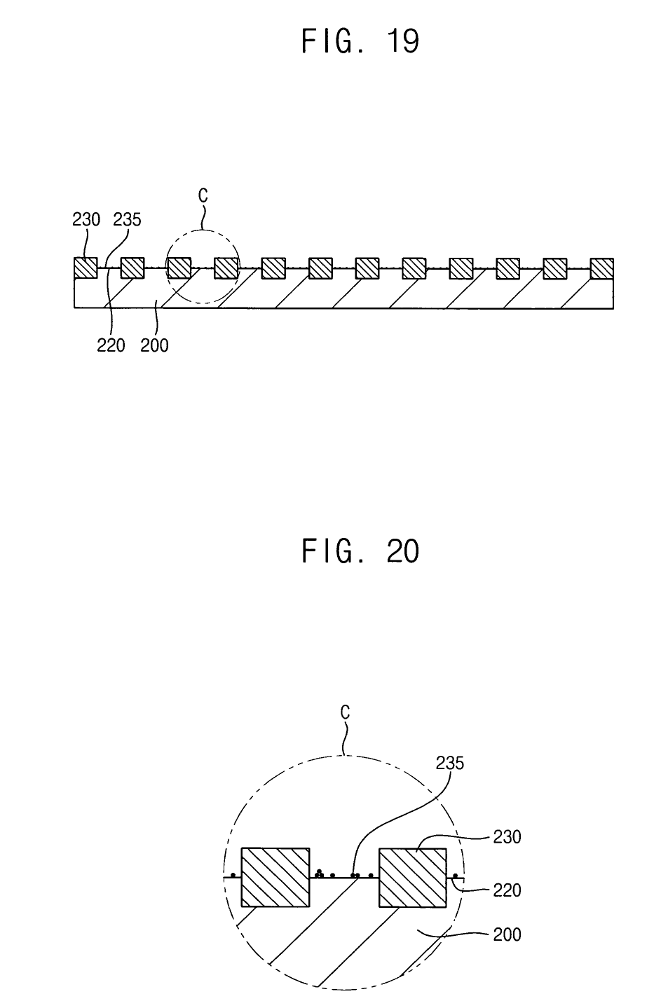

FIG. 19 is a cross-sectional view showing an exemplary second photoresist pattern that partially exposes the exemplary electrode terminal of FIG. 18 and an exemplary etching protector. FIG. 20 is an enlarged cross-sectional view showing portion ‘C’ shown in FIG. 19.

Referring to FIGS. 19 and 20, after the first photoresist pattern 210 is stripped from the semiconductor substrate 200, a photoresist thin film that covers the electrode terminal 220 is formed on the semiconductor substrate 200. The photoresist thin film is patterned through a photo process to form a second photoresist pattern 230 on the semiconductor substrate 200.

The second photoresist pattern 230 covers the semiconductor substrate 200, but does not cover the electrode terminal 220.

After the second photoresist pattern 230 is formed on the semiconductor substrate 200, etching protectors 235 having a bead shape are formed on the exposed electrode terminal 220. The etching protectors 235 protect a portion or portions of the electrode terminal 220 so that the portion or portions of the electrode terminal 220 are not etched by an etchant.

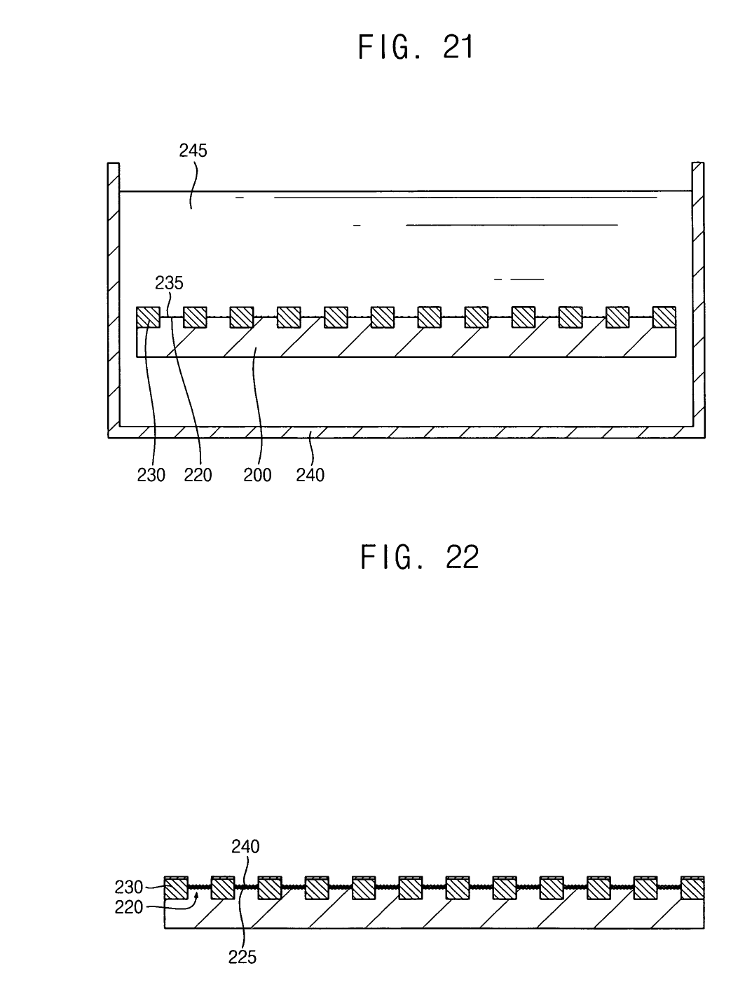

FIG. 21 is a cross-sectional view showing etching of the exemplary electrode terminal of the exemplary semiconductor substrate shown in FIG. 19.

Referring to FIG. 21, the electrode terminal 220, that is partially exposed on its upper surface thereof through the second photoresist pattern 230 positioned on the bottom surface of the semiconductor substrate 200, is dipped in a vessel 240 having an etchant 245 for partially etching the semiconductor substrate 200. The electrode terminal 220 is partially etched through a dry etching process or a wet etching process. The electrode terminal 220 is irregularly etched by the etchant 245 at locations not protected by the etching protectors 235 to form a surface increasing portion 225 having various dimensions on the electrode terminal 220.

FIG. 22 is a cross-sectional view showing exemplary conductive bumps formed on the exemplary electrode terminal shown in FIG. 21.

Referring to FIG. 22, the conductive bumps 250 are selectively formed on the surface increasing portion 225 on the electrode terminal 220 of the semiconductor substrate 200. For example, a metal is deposited on the surface increasing portion 225 through a sputtering process or a chemical vapor deposition process to form the conductive bumps 250. Examples of the metal that can be used for the conductive bumps 250 include gold Au, silver Ag, aluminum Al, copper Cu, etc.

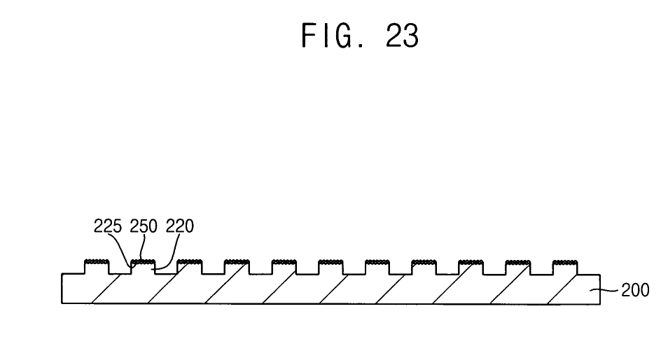

FIG. 23 is a cross-sectional view showing stripping of the exemplary second photoresist pattern from the exemplary semiconductor substrate shown in FIG. 22.

Referring to FIG. 23, after the conductive bumps 250 are formed on the electrode terminal 220, the second photoresist pattern 230 is stripped from the semiconductor substrate 200 through an ashing process to complete a driving circuit. The ashing process that can be used for stripping the second photoresist pattern 230 may be performed using oxygen plasma.

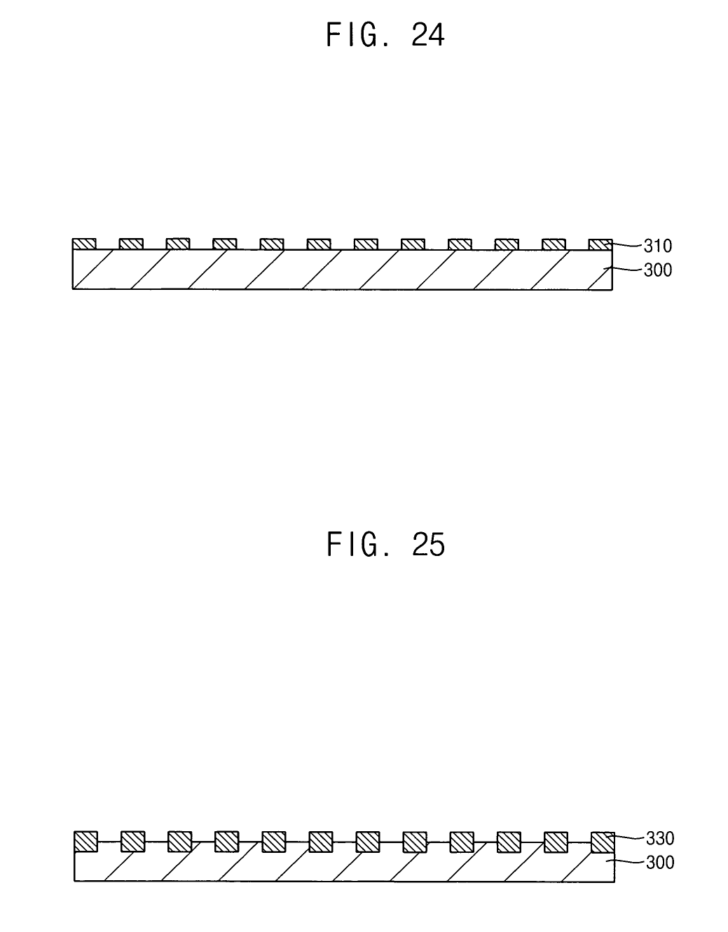

FIGS. 24 to 28 are cross-sectional views showing still another exemplary method of manufacturing an exemplary embodiment of a driving circuit in accordance with the present invention.

FIG. 24 is a cross-sectional view showing an exemplary first photoresist pattern for forming an exemplary electrode terminal on an exemplary semiconductor substrate.

Referring to FIG. 24, a photoresist thin film is coated on the semiconductor substrate 300 having a circuit part (not shown) through a spin coating process. The photoresist thin film is patterned through a photo process to form the first photoresist pattern 310 on the semiconductor substrate 300.

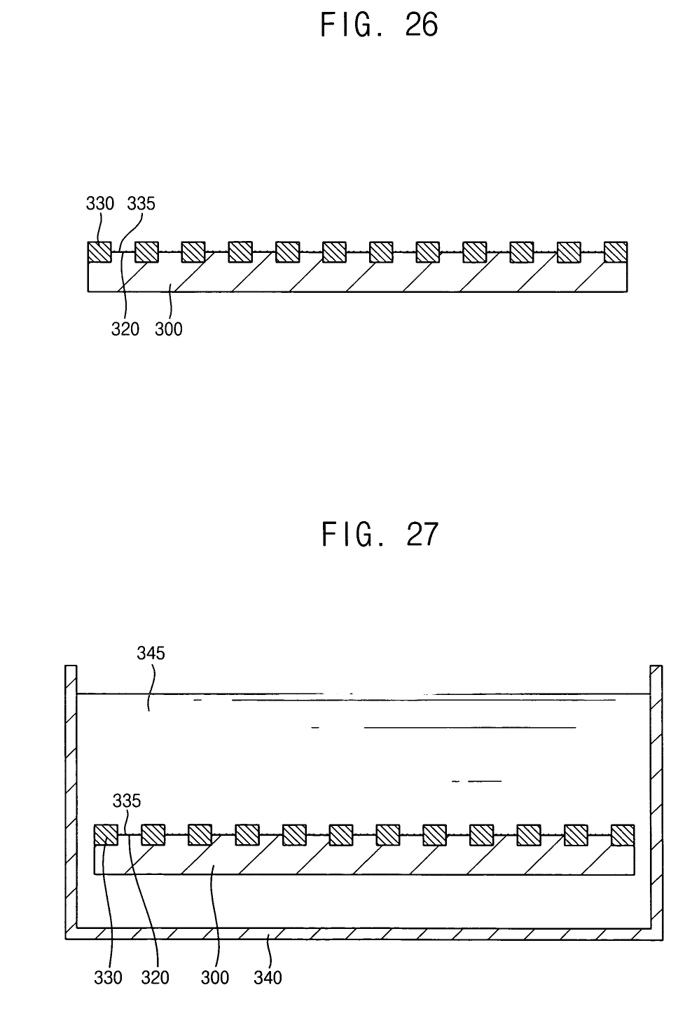

FIG. 25 is a cross-sectional view showing an exemplary electrode terminal formed on the exemplary semiconductor substrate shown in FIG. 24.

Referring to FIG. 25, the semiconductor substrate 300 is patterned through a dry etching process or a wet etching process using the first photoresist pattern 310 to form the electrode terminal 320 (shown in FIG. 26) that is electrically connected to the circuit part on the semiconductor substrate 300. The first photoresist pattern 310 (as shown in FIG. 24) is stripped from the semiconductor substrate 300 through an ashing process using oxygen plasma.

After the first photoresist pattern 310 is stripped from the semiconductor substrate 300, a photoresist thin film that covers the semiconductor substrate 300 including the electrode terminal 320 (as shown in FIG. 26) is formed on the semiconductor substrate 300. The photoresist thin film is patterned through a photo process to form a second photoresist pattern 330 on the semiconductor substrate 300.

The second photoresist pattern 330 covers the semiconductor substrate 300, but does not cover the electrode terminal 320.

Referring to FIG. 26, after the second photoresist pattern 330 is formed on the semiconductor substrate 300, catalysts 335 having a bead shape are formed on the exposed electrode terminal 320, such as on an upper surface of the electrode terminal 320. The catalysts 335 accelerate an etching process of a portion or portions of the electrode terminal 320.

FIG. 27 is a cross-sectional view showing etching of the exemplary electrode terminal of the exemplary semiconductor substrate shown in FIG. 26.

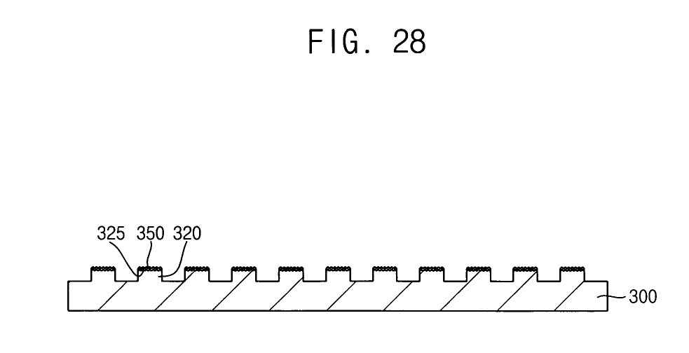

Referring to FIG. 27, the electrode terminal 320 that is partially exposed through the second photoresist pattern 330 is dipped in a vessel 340 having an etchant 345 for partially etching the semiconductor substrate 300. The electrode terminal 320 is partially etched through a dry etching process or a wet etching process. The electrode terminal 320 is irregularly etched by the catalysts 335 to form a surface increasing portion 325 (as shown in FIG. 28) having various dimensions on the electrode terminal 320. The electrode terminal 320 may be more etched at locations of the catalysts 335 than at other locations of the upper surface of the electrode terminal 320.

FIG. 28 is a cross-sectional view showing an exemplary conductive bump formed on the exemplary electrode terminal shown in FIG. 27.

Referring to FIG. 28, the conductive bump 350 is selectively formed on the surface increasing portion 325 on the electrode terminal 320 of the semiconductor substrate 300. For example, a metal is deposited on the surface increasing portion 325 through a sputtering process or a chemical vapor deposition process to form the conductive bump 350. Examples of the metal that can be used for the conductive bump 350 include gold Au, silver Ag, aluminum Al, copper Cu, etc. After the conductive bump 350 is formed on the electrode terminal 320, the second photoresist pattern 330 is stripped from the semiconductor substrate 300 through an ashing process to complete a driving circuit. The ashing process that can be used for stripping the second photoresist pattern 330 may be performed using oxygen plasma.

Display Device

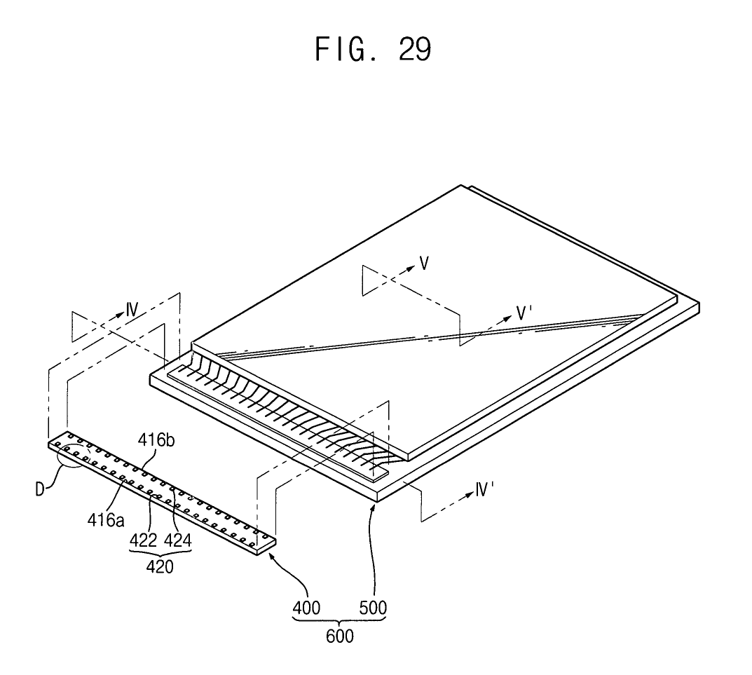

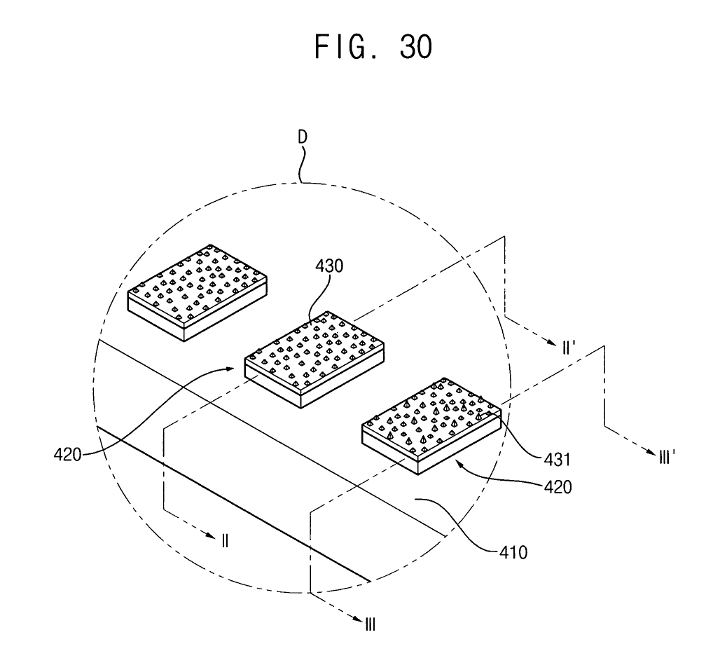

FIG. 29 is an exploded perspective view showing a portion of an exemplary embodiment of a display device in accordance with the present invention. FIG. 30 is an enlarged perspective view showing portion ‘D’ shown in FIG. 29.

Referring to FIGS. 29 and 30, a display device 600 includes a driving circuit 400 and a display substrate 500.

The driving circuit 400 includes a semiconductor substrate 410, an electrode terminal 420, and a conductive bump 430. Alternatively, the driving circuit 400 may further include a plurality of electrode terminals 420 and a plurality of conductive bumps 430.

The semiconductor substrate 410 may include a circuit part (not shown) that converts an externally provided image signal into a driving signal. The circuit part (not shown) may be formed through thin film manufacturing processes. The electrode terminal 420 may be formed on a bottom surface of the semiconductor substrate 410, and may protrude from a face of the bottom surface. The electrode terminal 420 includes a signal input terminal portion 422 and a signal output terminal portion 424. The externally provided image signal is applied to the circuit part (not shown) of the semiconductor substrate 410 through the signal input terminal portion 422. The driving signal generated from the circuit part (not shown) is applied to the driving circuit 400 through the signal output terminal portion 424.

A plurality of the signal input terminal portions 422 may be arranged on a peripheral portion adjacent to a first edge line 416a of the semiconductor substrate 410. That is, the signal input terminal portions 422 may be dispersed along a side of the semiconductor substrate 410.

A plurality of the signal output terminal portions 424 may be arranged on the peripheral portion adjacent to a second edge line 416b of the semiconductor substrate 410. The second edge line 416b is opposite to the first edge line 416a. That is, the signal output terminal portions 424 may be dispersed along another side of the semiconductor substrate 410.

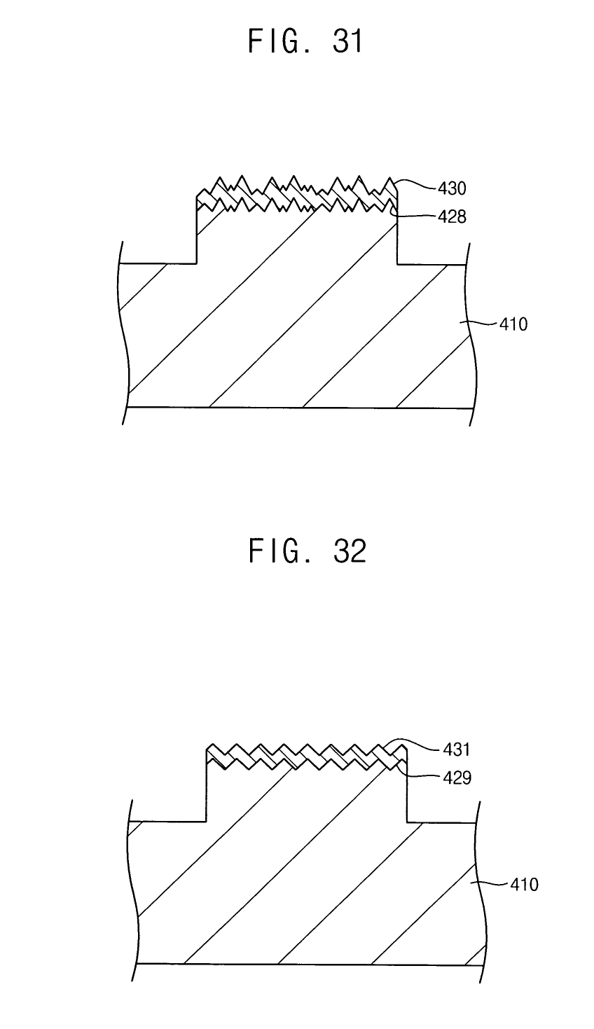

FIG. 31 is a cross-sectional view taken along line II-II′ shown in FIG. 30.

Referring to FIG. 31, a plurality of surface increasing portions 428 may be formed on an upper surface of the electrode terminal 420 that includes the signal input terminal portions 422 and the signal output terminal portions 424. That is, the electrode terminal 420 includes a lower surface attached to the bottom surface of the semiconductor substrate 410 and an upper surface spaced from the bottom surface of the semiconductor substrate 410. The upper surface of the electrode terminal 420 includes the plurality of surface increasing portions 428. In absence of the plurality of surface increasing portions 428, the upper surface of the electrode terminal 420 would have a smaller surface area that the electrode terminal 420 having the plurality of surface increasing portions 428.

Each of the surface increasing portions 428 may have various dimensions. The dimension includes height, bottom surface, volume, etc. For example, the height of each surface increasing portion 428 may be about 1 to about 10 μm.

For example, the surface increasing portion 428 may have a substantially circular cone shape, a substantially triangular pyramid shape, a substantially quadrangular pyramid shape, a substantially polygonal pyramid shape, etc., when viewed from above, that is, when viewed in plan.

The conductive bump 430 is formed on the electrode terminal 420 having an increased surface. The conductive bump 430 may include a highly conductive metal. Examples of the metal that can be used for the conductive bump 430 include gold Au, silver Ag, aluminum Al, copper Cu, etc. The conductive bump 430 may be formed on the electrode terminal 420 through a sputtering process, a chemical vapor deposition process, a plating process, an electro less plating process, etc. For example, the conductive bump 430 has a convex and concave shape to be combined with the electrode terminal 420. That is, a surface area of the conductive bump 430 is also increased as compared to a surface area of a conductive bump having planar faces.

FIG. 32 is a cross-sectional view taken along line III-III′ shown in FIG. 30.

Referring to FIG. 32, the electrode terminal 420 may have a convex shape that is protruded from a bottom surface of the semiconductor substrate 410. At least one surface increasing portion 429 may be formed on the electrode terminal 420.

The surface increasing portions 429 may have a constant dimension. The dimension includes height, bottom surface, volume, etc. For example, the height of the surface increasing portion 429 may be about 1 to about 10 μm. The surface increasing portion 429 may have a substantially circular cone shape, a substantially triangular pyramid shape, a substantially quadrangular pyramid shape, a substantially polygonal pyramid shape, etc., when viewed on a plane, such as in plan view.

The conductive bump 431 is formed on the electrode terminal 420. The conductive bump 431 may include a highly conductive metal. Examples of the metal that can be used for the conductive bump 431 include gold Au, silver Ag, aluminum Al, copper Cu, etc. The conductive bump 431 may be formed on the electrode terminal 420 through a sputtering process, a chemical vapor deposition process, a plating process, an electro less plating process, etc. For example, the conductive bump 431 has convex and concave shapes to be combined with the electrode terminal 420. That is, a surface area of the conductive bump 431 is also increased as compared to a surface area of a conductive bump having planar faces.

In FIGS. 29 to 32, the surface area of the conductive bumps 430 and 431 are greatly increased to decrease a contact resistance between the electrode terminal 420 and signal lines that are electrically connected to the conductive bumps 430 and 431. While the driving circuit 400 is shown as including both surface increasing portions 428 having various dimensions and surface increasing portions 429 having constant dimensions, the driving circuit 400 may alternatively include either electrode terminals 420 having only surface increasing portions 428 or electrode terminals 420 having only surface increasing portions 429.

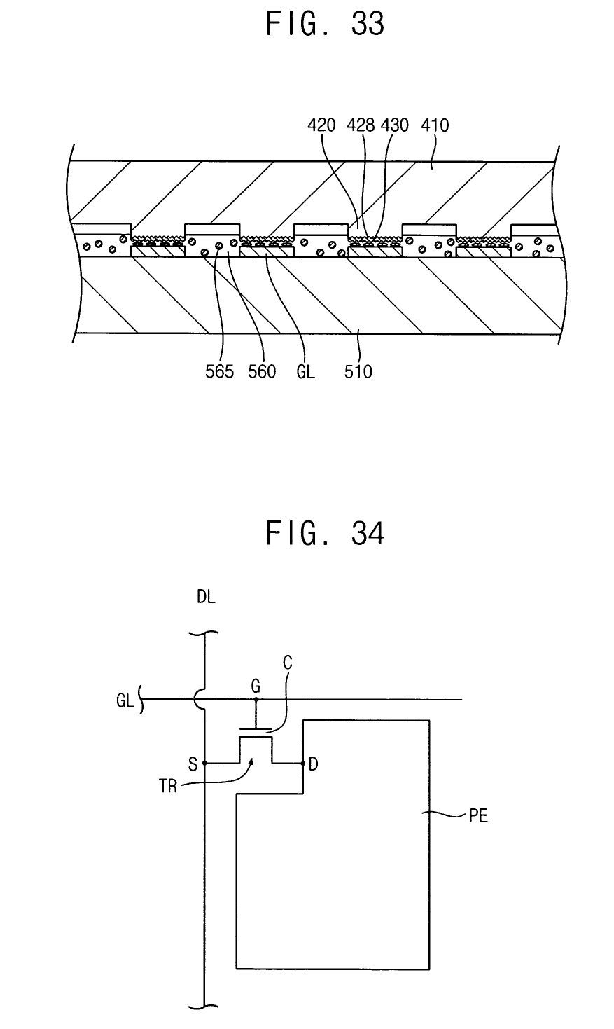

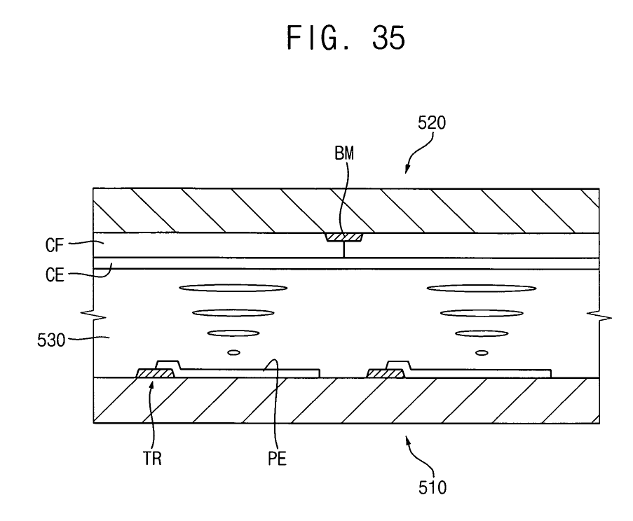

FIG. 33 is a cross-sectional view taken along line IV-IV′ shown in FIG. 29. FIG. 34 is a plan view showing an exemplary first display substrate shown in FIG. 29. FIG. 35 is a cross-sectional view taken along line V-V′ shown in FIG. 29.

Referring to FIGS. 33 to 35, the display substrate 500 includes a first display substrate 510 and a second display substrate 520.

The first display substrate 510 includes a plurality of pixel electrodes PE and a plurality of thin film transistors TR. The thin film transistors TR are electrically connected to the pixel electrodes PE, respectively.

Each of the pixel electrodes PE may include a transparent conductive material. Examples of the transparent conductive material that can be used for the pixel electrodes PE include, but are not limited to, indium tin oxide (“ITO”), indium zinc oxide (“IZO”), etc.

Each of the thin film transistors TR includes a gate electrode G, a source electrode S, an insulating layer (not shown), a channel layer C, and a drain electrode D. The gate electrode G is electrically connected to a gate line GL. The source electrode S is electrically connected to a data line DL. The first display substrate 510 may include a plurality of gate lines GL and a plurality of data lines DL extending substantially perpendicularly with respect to the gate lines GL. The gate electrode G is electrically insulated from the source electrode S and the drain electrode D by the insulating layer (not shown). The channel layer C is on the insulating layer (not shown) corresponding to the gate electrode G, and electrically connected between the source and drain electrodes S and D. Each of the pixel electrodes PE is electrically connected to the drain electrode D. Thus, a plurality of pixel areas are formed in a matrix configuration.

The second display substrate 520 corresponds to the first display substrate 510. A black matrix BM is formed on the second display substrate 520. The black matrix BM blocks a light that leaks between the pixel electrodes PE of the first display substrate 510. In other words, the black matrix BM may be formed on the second display substrate 520 in areas corresponding to the signal lines and thin film transistors TR of the first display substrate 520.

The second display substrate 520 may further include a color filter CF. The color filter CF corresponds to each of the pixel electrodes PE that are formed on the first display substrate 510, and may include portions surrounded by the black matrix BM. The color filter CF includes a red color filter portion, a green color filter portion, and a blue color filter portion.

A common electrode CE may be on the second display substrate 520, and corresponds to the pixel electrodes PE. The common electrode CE may include a transparent conductive material. Examples of the transparent conductive material that can be used for the common electrode CE include, but are not limited to, the indium tin oxide (“ITO”), indium zinc oxide (“IZO”), etc.

A liquid crystal layer 530 may be interposed between the first and the second display substrates 510 and 520 in a liquid crystal display (“LCD”) device.

The signal line, such as, for example, the gate line GL, is electrically connected to the conductive bump 430 of the driving circuit 400 through an anisotropic conductive film (“ACF”) 560. The ACF 560 may include a plurality of micro conductive balls 565. In FIG. 33, the micro conductive balls 565 are effectively compressed by the conductive bump 430 having the convex and concave shape to improve electric characteristics between the driving circuit 400 and the signal line. A driving circuit may also be provided for connection to the data lines DL of the display substrate 500.

While the display substrate 500 is illustrated and described as an LCD device, it should be understood that the driving circuit 400 may be provided for other types of display devices including, but not limited to, organic light emitting display (“OLED”) devices.

According to the present invention, the surface area of the electrode terminal of the driving circuit that generates the driving signal for displaying the image and the surface area of the conductive bump that is formed on the electrode terminal are increased so that the contact resistance between the electrode terminal and the conductive bump is decreased, thereby improving an image display quality of the display device. Contact resistance between the electrode terminal and a signal line that is electrically connected to the conductive bump is decreased as a result of the increased surface area of the conductive bump.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A driving circuit comprising:
a semiconductor substrate;
an electrode terminal on the semiconductor substrate, the electrode terminal including surface increasing portions on an upper surface of the electrode terminal increasing a surface area of the electrode terminal, the surface increasing portions having various dimensions; and
a conductive bump covering the surface increasing portions.

2. The driving circuit of claim 1, wherein the electrode terminal is substantially in parallel with a side of the semiconductor substrate.

3. The driving circuit of claim 1, wherein the surface increasing portions have at least one shape selected from a group consisting of a substantially circular cone shape, a substantially triangular pyramid shape, a substantially quadrangular pyramid shape, and a substantially polygonal pyramid shape when viewed in plan.

4. The driving circuit of claim 3, wherein the dimensions of the surface increasing portions are heights of the surface increasing portions.

5. The driving circuit of claim 4, wherein the heights of the surface increasing portions are about 1 μm to about 10 μm.

6. The driving circuit of claim 1, wherein a number of the surface increasing portions in an area of about 1,000 μm² is about ten to one thousand.

7. The driving circuit of claim 1, wherein the electrode terminal comprises a signal input terminal portion receiving an externally provided image signal and a signal output terminal portion through which a driving signal generated from a circuit part of the semiconductor substrate is outputted.

8. The driving circuit of claim 1, wherein the conductive bump has a non-planar outer surface corresponding to the surface increasing portions of the electrode terminal.

9. A driving circuit comprising:
a semiconductor substrate;
an electrode terminal on the semiconductor substrate, the electrode terminal including surface increasing portions on an upper surface of the electrode terminal increasing a surface area of the electrode terminal, the surface increasing portions each having substantially same dimensions; and
a conductive bump covering the surface increasing portions.

10. The driving circuit of claim 9, wherein the electrode terminal is substantially in parallel with a side of the semiconductor substrate.

11. The driving circuit of claim 9, wherein the surface increasing portions have at least one shape selected from a group consisting of a substantially circular cone shape, a substantially triangular pyramid shape, a substantially quadrangular pyramid shape, and a substantially polygonal pyramid shape.

12. The driving circuit of claim 11, wherein the dimensions of the surface increasing portions are heights of the surface increasing portions.

13. The driving circuit of claim 12, wherein the heights of the surface increasing portions are about 1 μm to about 10 μm.

14. The driving circuit of claim 9, wherein a number of the surface increasing portions in an area of about 1,000 μm² is about ten to one thousand.

15. The driving circuit of claim 9, wherein the conductive bump has a non-planar outer surface corresponding to the surface increasing portions of the electrode terminal.

16. A method of manufacturing a driving circuit comprising:
preparing a pretreatment solution including a reacting solution for forming silicon compound;
preparing a treatment solution from the pretreatment solution and silicon, the treatment solution including the silicon compound; and
dipping a substrate having an electrode terminal that is partially exposed by the silicon compound in the treatment solution and partially etching the electrode terminal using the treatment solution.

17. The method of claim 16, wherein the pretreatment solution comprises a deionized water.

18. The method of claim 17, wherein preparing the pretreatment solution further comprises stirring the pretreatment solution for about one minute to about two minutes using a nitrogen bubble at a temperature of about 85° C. to about 95° C.

19. The method of claim 17, wherein the pretreatment solution further comprises isopropyl alcohol.

20. The method of claim 19, wherein a volumetric ratio of the deionized water, the reacting solution, and the isopropyl alcohol is about 1 L:15×10⁻³ L:14×10⁻³ L.

21. The method of claim 19, wherein a volumetric ratio of the deionized water, the reacting solution, and the isopropyl alcohol is about 14 L:0.21 L:0.2 L, and a number, diameter, and thickness of silicon substrates dipped in the treatment solution are about twenty four, about eight inches, and about 480 μm, respectively.

22. The method of claim 16, wherein the treatment solution comprises sodium hydroxide or potassium hydroxide.

23. The method of claim 16, wherein the silicon compound comprises sodium silicate.

24. The method of claim 16, wherein preparing the pretreatment solution and preparing the treatment solution is repeated about three to five times.

25. The method of claim 16, further comprising forming a surface increasing portion on the electrode terminal, wherein a height of the surface increasing portion is about 1 μm to about 10 μm.

26. The method of claim 25, wherein the surface increasing portion has at least one shape selected from a group consisting of a substantially circular cone shape, a substantially triangular pyramid shape, a substantially quadrangular pyramid shape, and a substantially polygonal pyramid shape.

27. The method of claim 16, further comprising forming a bump on the electrode terminal, wherein the bump comprises a metal.

28. A method of manufacturing a driving circuit comprising:
forming a photoresist pattern on an electrode terminal exposed on a semiconductor substrate having a circuit part that converts an image signal into a driving signal; and
partially etching the electrode terminal using the photoresist pattern as an etching mask to form a surface increasing portion on the electrode terminal.

29. The method of claim 28, further comprising forming a conductive bump on the electrode terminal using the photoresist pattern as a mask.

30. A method of manufacturing a driving circuit comprising:
attaching an etching protector having a bead shape to an electrode terminal exposed on a semiconductor substrate having a circuit part that converts an image signal into a driving signal; and
partially etching the electrode terminal using the etching protector as an etching mask to form a surface increasing portion on the electrode terminal.

31. The method of claim 30, further comprising forming a conductive bump on the electrode terminal using a photoresist pattern as a mask.

32. The method of claim 31, wherein partially etching the electrode terminal further comprises dry etching the electrode terminal.

33. A method of manufacturing a driving circuit comprising:
attaching a catalyst accelerating an etching process to an electrode terminal exposed on a semiconductor substrate having a circuit part that converts an image signal into a driving signal; and
partially etching the electrode terminal using the catalyst as an etching mask to form a surface increasing portion on the electrode terminal.

34. The method of claim 33, further comprising forming a conductive bump on the electrode terminal using a photoresist pattern as a mask.

35. The method of claim 34, wherein partially etching the electrode terminal further comprises wet etching the electrode terminal.

36. A display device comprising:
a display substrate including a display part displaying an image based on a driving signal applied from a signal input portion; and
a driving circuit including:
a semiconductor substrate having a circuit part generating the driving signal;
an electrode terminal on the semiconductor substrate corresponding to the signal input portion, the electrode terminal including surface increasing portions on an upper surface of the electrode terminal to increase a surface area of the electrode terminal; and
a conductive bump on the electrode terminal, the conductive bump electrically connected to the signal input portion.

37. The display device of claim 36, wherein the surface increasing portions have substantially same dimensions.

38. The display device of claim 36, wherein the surface increasing portions have various dimensions.

39. The display device of claim 36, wherein heights of the surface increasing portions are about 1 μm to about 10 μm.

40. The display device of claim 39, wherein a number of the surface increasing portions in an area of about 1,000 μm² is about ten to one thousand.

41. The display device of claim 36, wherein the surface increasing portions have at least one shape selected from a group consisting of a substantially circular cone shape, a substantially triangular pyramid shape, a substantially quadrangular pyramid shape, and a substantially polygonal pyramid shape.

42. The display device of claim 36, wherein the display substrate comprises:
a first substrate including a plurality of first electrodes;
a second substrate corresponding to the first substrate, the second substrate including a second electrode; and
a liquid crystal layer interposed between the first and the second substrates.

43. The display device of claim 36, wherein the conductive bump has an increased surface area corresponding to an increased surface area of the electrode terminal, the increased surface area of the conductive bump decreasing contact resistance between the electrode terminal and the signal input portion.

44. A method of improving an image display quality in a display device having a driving circuit and a display panel, the method comprising:
decreasing contact resistance between an electrode terminal of the driving circuit and a signal line of the display panel by providing a non-planar conductive bump on the electrode terminal to increase a surface area of the conductive bump.

45. The method of claim 44, wherein providing a non-planar conductive bump includes providing surface increasing portions on the electrode terminal prior to covering the electrode terminal with the conductive bump.
